(19) United States
(12) Patent Application Publication
(10) Pub. No.: US 2007/0027749 A1
(43) Pub. Date: Feb. 1, 2007

(54) Advertisement detection

(75) Inventors: Jose Abad Peiro, Barcelona (ES); Sherif Yacoub, Barcelona (ES); Jose Antonio Sanchez, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/189,930

(22) Filed: Jul. 27, 2005

(51) Int. Cl. G06Q 30/00

(52) U.S. Cl. 705/14

(57) ABSTRACT

A method of detecting advertisements within a document comprising: identifying at least one region within an electronic version of the document; determining at least one property of the at least one region; and determining whether a region is an advertisement according to rules applied to the properties of the at least one region.

### TECHNICAL FIELD

Embodiments of the present subject matter relate to methods and apparatus for detecting an advertisement in a document. The document may be a document provided on a physical media or a document held in an electronic form. The physical media will generally be paper but may equally be in non-paper form, for example any of the following non-exhaustive list: cardboard, plastics material, or the like.

### BACKGROUND

The conversion of physical documents into a machine intelligible digital form that is suitable for electronic archival purposes and digital libraries is becoming more of a possibility. However, a number of technical problems exist that make the conversion of such physical documents problematic. It desirable to increase the accuracy with which a physical document can be converted in order that the speed at which the process can be performed can be increased thereby increasing the throughput and increasing the rate at which physical documents can be converted.

In general, the conversion process comprises two parts. A first part scans the physical document, using a conversion device such as a scanner, camera, copier, or the like, which generates an electronic image representing the document. Although the documents will generally be paper, they may be any physical medium such as paper, card, plastic and the like. The electronic image representing the or each physical document is then converted, in a second part of the conversion process, into another electronic version that is meaningful to machines and to human beings and which may be thought of as a machine intelligible digital form. In such a second part of the conversion process, a set of analysis and recognition processes are performed. Often there is a third stage: a human check of the quality of the machine-converted material, and human correction of it if it needs correcting. It is desirable that the second recognition process is able to accurately reproduce the contents of the or each physical document since this will reduce the amount of human intervention and checking that is required. It will be appreciated that if large volumes of physical documents are to be converted into digital form that it may not be possible for a human to check each digital form of the each physical document due to time constraints.

Techniques such as OCR (Optical Character recognition) and ICR (Intelligent Character Recognition) are well known second parts of the conversion process that allow electronic images of a physical document to be converted in digital form. The accuracy of such systems depends on the nature of the document content, the quality of the scan and/or the complexity of the layout of the document. The accuracy of the conversion to digital form may only approach 90% to 95%. Such accuracy is not sufficient to rule out manual checking of the conversion and there is therefore a technical drive to increase the accuracy of these processes. The fewer corrections a human has to make the better. It is possible to check in a given time a larger number of documents that do not need corrections to be made to them than it is to both check them and correct them.

### SUMMARY

According to a first aspect of the invention there is provided a computer-implemented method of detecting advertisements within a document comprising: using a computer to: identify at least one region within an electronic version of the document; determine at least one property of the at least one region; and determine whether a region is an advertisement according to rules applied to the properties of the at least one region.

An advertisement is a public promotion of a product or service which is to be distinguished from information that is published with the only aim of informing the reader.

Once a region of a document has been identified as an advertisement (automatically by a machine) a link can be made between the text before and after the advertisement (e.g. automatically by machine) so as to omit the advertisement from a machine converted document, or the advertisement can be flagged as such in the machine-converted form. Flagging regions as advertisements or non-advertisements (e.g. articles) allows a database of documents to be searched for either advertisements or non-advertisements (articles). In a similar fashion, a user may choose to view a document in different formats, for example, a format that includes advertisements in the document and a format in which the adverts have been deleted from the document.

According to an embodiment of the invention once an advertisement region has been detected there is the option to remove the advertisement region from the electronic version of the document or to keep the advertisement in the document. If the advertisement region is removed then the removed region may be stored, for example in computer memory. Similarly, if the advertisement region is kept in the electronic version of the document then a copy of the advertisement region can be made and this copy stored.

If the advertisement is removed from the electronic version of the document then there is less material for a human checker to check if a human checking operation is being performed.

If the advertisement region is kept in the document then once an advertisement region is detected the degree of readability of an article in a page on which the advertisement region has been inserted can be considered. In this way the effect of the insertion of the advert on the readability of the document can be assessed. In a similar fashion the level of quality of the designed page that includes the advertisement can be measured. This may be of interest to publisher, the company who placed the advert, and/or the author of any article that accompanies the advertisement on the page. The level of quality can be measured using software tools, for example, such as Quark or Illustrator. Quality parameters that can be measured include the alignment of text within a text block, the alignment of text and image blocks with each other, the consistency of font styles and families across logically connected text blocks, left to right reading flow consistency for occidental publications, and consistent location and layout properties of page attributes such as page number, headers and footers, etc.

It is beneficial for production workflows and knowledge management tools to understand the content of the documents being managed. In one example, for a production workflow for a newspaper publishing house, a publisher may to trace the impact of an advertisement on their publications, e.g., by assessing factors such as whether the advertisement improves the appearance of the publication or whether the product announced by the advertisements aligns with the audience targeted by the publication. Traditionally such factors are reviewed manually whereas embodiments of the current invention enable such publishing workflows to be automated, that is, the assessment of such factors can be automated. In another example, an advertising house, may wish to trace how publications evolve so that they may be more successful when designing new advertisement campaigns. In another example, the product manufacturer itself (who may spend a large amount of money in different advertisement campaigns) may want to assess what is published against a certain set of rules, e.g., color consistency of logos, font styles, readability (e.g. the readability of the message in the advertisement itself) in different languages. Such a system enables analysis of messaging in a new type of workflow where all advertisement assets rely efficiently with the publication in which they appear.

For a large corpus of documents, for example back issues of a periodical that date back several years, or several decades, the evolution of an advertisement for a particular company can be measured. The company may be interested to assess how the published image of the company or the values of the company, as represented by the advertisements, have evolved.

The removal of advertisements from an electronic version of a document, such as, for example, a scanned magazine, makes it easier to extract article text from the document.

The removal of advertisements optimises document workflows by avoiding the need to process complex advertisement pages.

For text-to-speech machines, used by visibly impaired people, the removal of irrelevant zones from a page (such as advertisements) allows the user to read directly articles in the document. It can help to avoid wasting the time of a person listening to an article.

The detection of advertisements can be used for SPAM detection/removal when documents arrive by email.

According to an embodiment of the invention the determination that a region is an advertisement comprises: making a provisional determination that a region is an advertisement; making a decision as to the correctness of the provisional determination based on the subsequent determination of the semantics of other document regions; and changing the provisional determination if it is decided that the provisional determination is incorrect.

The semantic of a zone is determined by the reason for which the zone has been included during composition of the page. There can be different types of semantics, e.g., table of content zones, or page number zones. For the purposes of this specification the semantic of zones are described as advertisement or non-advertisement (article) zones. Advertisement and article semantics can be subdivided into finer grain categories, for example images can be further categorized as logos or full-page images. Similarly, text zones can be further categorized as titles, sections, footnotes, etc.

A region can be one of the following region types: (i) zones; (ii) clusters of zones; (iii) document pages; and (iv) multi-page documents. The properties of any combination of these region types can be used to determine whether a region is an advertisement region. Additionally, properties determined from a plurality of documents can be used to make the determination of whether or not a document region is an advertisement region.

It should be appreciated that embodiments of the invention may only use one rule based on more than one property, use only one rule based one property, use more than one rule with each rule based on one property, or use more than one rule where the each rule is based on one or more properties. A rule or set of rules may be applied to a single type of document region, all types of document region or a sub-group of document regions.

At least one property of a document zone may be determined, the at least one property being chosen from: (i) the position of the zone on a document page or pages; (ii) the size of the zone; (iii) the amount of text in the zone; (iv) the typeface of the zone; (v) the type of the zone, (vi) the content of the zone; and (vii) any combination of (i) to (vi).

A plurality of zones can be determined to belong to a cluster of zones if the zones satisfy rules chosen from: (i) the zones are geometrically aligned in a specified manner; (ii) the zones have the same or similar typography; (iii) the zones have the same or similar formatting; (iv) at least one of the colour, contrast, saturation and brightness of the zones are the same or similar; and (v) any combination of (i) to (iv).

A plurality of zones can be determined to belong to a cluster of zones if the zones satisfy rules based on properties chosen from: (i) the proximity of the zones to each other; (ii) the position of the zones relative to each other; (iii) the content of the zones; (iv) the text density in the zones; and (v) any combination of (i) to (iv).

The properties used to determine whether a document area is an advertisement may comprise properties of document pages, the properties being chosen from (i) the number of zones on the page having a common semantic; (ii) the coverage of the page by the zones having a particular semantic; (iii) the text density on the page; (iv) font variability; (v) font size variability; (vi) interline space variability; (vii) the number of lines of text per zone for the zones on the page; (viii) the number of columns; (ix) the number of rows; (x) the shape of columns; (xi) the shape of rows; and (xii) any combination of (i) to (xi).

The text density, font variability, font size variability, and interline space variability, on the page may be this assessed for the whole page, for individual zones on the page or for clusters on the page. These properties may also be assessed for sets of pages and collections of documents.

In an embodiment of the invention, for a multi-page document, the method comprises: determining a page contains a table of contents; analysing the table of contents to determine which pages of the document contain articles; and determining the zones in those pages to be article zones.

In an embodiment of the invention, if a zone spreads across a first page and a consecutive adjacent page and the first page is determined to be an article page then the consecutive adjacent page is also determined to be an article page.

For example, if a zone spreads across a left hand page and a consecutive right hand page and the left hand page is determined to be an article page then the right hand page is also determined to be an article page.

The terms “left hand page” and “right hand page” take their normal meaning and apply to a document that is read in a normal fashion for occidental language documents. For some languages, for example Chinese and Japanese, the pages may be read from top to bottom or from right to left and analogous rules can be applied to documents published in these languages.

In an embodiment of the invention, for a multi-page document the method comprises: determining a zone spreads across a first page and a consecutive adjacent page; and determining the semantic of the consecutive adjacent page to be the same semantic as the first page. A page in which all zones are advertisement is an advertisement page. Sometimes rules detect a page to be an advertisement page, e.g., when the area of the page covered with text zones is too low under a certain threshold. This generally only happens on an advertisement page; in this case all zones found in the page can also be tagged as advertisements, even though they had not otherwise been detected as such.

The rules used to determine whether a document area is an advertisement may include rules which are generated from information gathered from a plurality of documents, the method comprising formulating a lexicon of terms by extracting and maintaining terms held in lexicons associated with individual documents.

The rules may be generated from information gathered from a plurality of document issues, the method comprising identifying elements that repeat from document issue to document issue. The repeating element may be a trade name such as a company name, a product name or a trade mark. Repeating elements found in a publication can also vary over the years that the publication is produced, for example company logos and names suffer variations over the years, and still represent the same product.

A second aspect of the invention provides a method of detecting advertisements within a document comprising: processing an electronic version of the document to identify at least one region within the document, the at least one region being chosen from the following region types: (i) zones; (ii) clusters of zones; (iii) document pages; (iv) multi-page documents; (v) any combination of (i) to (iv); determining at least one property of the at least one region; and determining whether a zone is an advertisement according to rules applied to the properties of the at least one region; extracting determined advertisement zones from the electronic version of the document.

A third aspect of the invention provides a system for detecting advertisements within a document comprising a processor adapted to: identify at least one region within an electronic version of the document; determine at least one property of the at least one region; and determine whether a region is an advertisement according to rules applied to the properties of the at least one region.

The processor may be adapted to remove or mark at least one region that has been determined to be an advertisement from the electronic version of the document.

In an embodiment of the invention the system comprises a memory for storing the at least one advertisement region removed from the electronic version of the document. The memory may also be used for storing a copy of at least one region which is determined to be an advertisement when the at least one advertisement region is kept in the electronic version of the document.

A fourth aspect of the invention provides a computer program product encoded with software which run on a processor, is adapted to: identify at least one region within an electronic version of the document; determine at least one property of the at least one region; and determine whether a region is an advertisement according to rules applied to the properties of the at least one region.

### BRIEF DESCRIPTION OF THE DRAWINGS

There now follows by way of example only a detailed description of embodiments of the current invention of which:

FIG. 1 schematically shows a computer programmed to provide an embodiment of the present invention;

FIG. 2 shows a flow chart outlining one embodiment of the present invention;

FIG. 3 shows a page from a non-machine intelligible document used with an embodiment of the invention;

FIG. 4 shows the page of FIG. 3 on which has been highlighted zones used by subsequent processing according to an embodiment of the invention;

FIG. 5 is a schematic illustration of example uses of an advertisement detection system according to an embodiment of the invention; and

FIG. 6 is a schematic illustration of the architecture of an advertisement detection system according to an embodiment of the invention.

### DETAILED DESCRIPTION OF THE DRAWINGS

Some embodiments of the invention may be used to convert physical documents having human discernible information thereon, such as text, or the like, into a machine intelligible digital form in which the human discernible information becomes processable by a processing circuitry. The term physical document is intended to cover any document that may be handled by a user and includes mediums such as paper, card, plastics, glass and the like, although the medium may generally be paper.

Embodiments of the invention may be used to convert electronic documents into a machine intelligible form. Electronic documents may be held in a format such that they are represented as a bit map, vector representation, or the like, in which the content is not machine-intelligible although they will contain human discernible information. Examples of such formats include any of the following JPEG'S, TIFFS, non-editable PDF's, and the like.

By “machine intelligible form” is meant a form of representation of text where the image of text is represented as characteristics from a character set (e.g. ASCII) which represents alphanumeric characters in coded bits/bytes. This often, or practicality always, makes a machine-intelligible form of text machine-searchable to look for specified words or phrases. “Machine-intelligible form” is not storing the text as an image (e.g. bitmap or jpeg or TIFF).

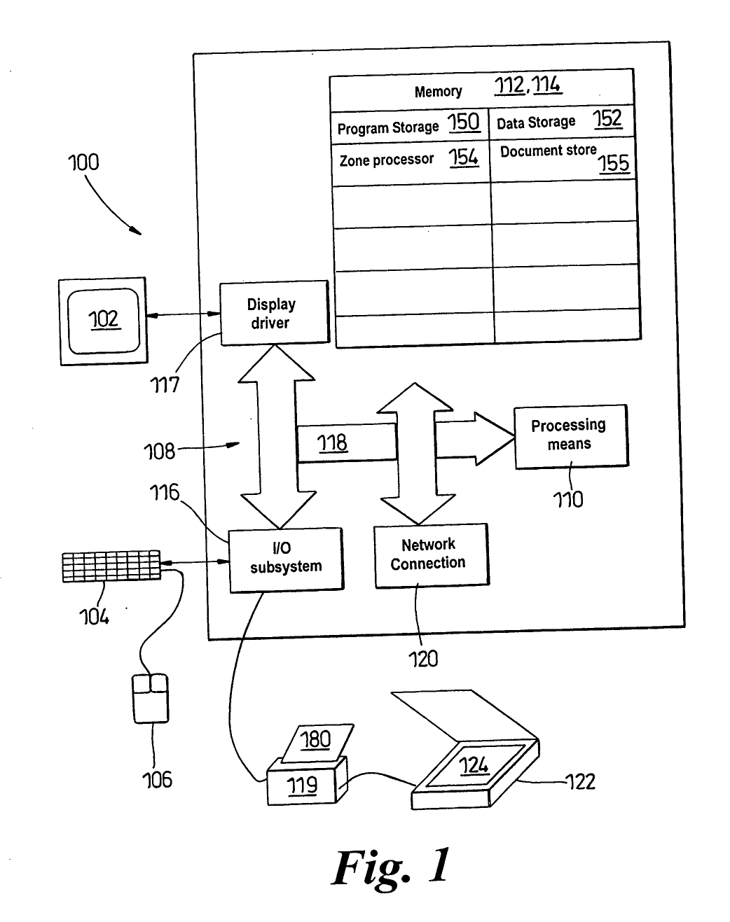

FIG. 1 shows a computer 100 arranged to accept data and to process that data. The computer 100 comprises a display means 102, in this case an LCD (Liquid Crystal Display) monitor, a keyboard 104, a mouse 106 and processing circuitry 108. It will be appreciated that other display means such as LEP (Light Emitting Polymer), CRT (Cathode Ray Tube) displays, projectors, televisions and the like may be equally possible.

The processing circuitry 108 represents a typical machine and comprises a processing means 110, a hard drive 112, memory 114 (RAM and ROM), an I/O subsystem 116 and a display driver 117 which all communicate with one another, as is known in the art, via a system bus 118. The processing means 110 (often referred to as a processor) typically comprises at least one INTEL™ PENTIUM™ series processor, (although it is of course possible for other processors to be used) and performs calculations on data. Other processors may include processors such as the AMD™ ATHLON™, POWERPC™, DIGITAL™ ALPHA™, and the like.

The hard drive 112 is used as mass storage for programs and other data and may be used as a virtual memory. Use of the memory 114 is described in greater detail below.

The keyboard 104 and the mouse 106 provide input means to the processing means 110. Other devices such as CDROMS, DVD ROMS, scanners, etc. could be coupled to the system bus 118 and allow for storage of data, communication with other computers over a network, etc.

The I/O (Input/Output) subsystem 116 is arranged to receive inputs from the keyboard 104, mouse 106, printer 119 and from the processing means 110 and may allow communication from other external and/or internal devices. The display driver 117 allows the processing means 110 to display information on the display means 102.

The processing circuitry 108 further comprises a transmitting/receiving means 120, which is arranged to allow the processing circuitry 108 to communicate with a network. The transmitting/receiving means 120 also communicates with the processing circuitry 108 via the bus 118.

The processing circuitry 108 could have the architecture known as a PC, originally based on the IBM™ specification, but could equally have other architectures. The processing circuitry 108 may be an APPLE™, or may be a RISC system, and may run a variety of operating systems (perhaps HP-UX, LINUX, UNIX, MICROSOFT™ NT, AIX™, or the like). The processing circuitry 108 may also be provided by devices such as Personal Digital Assistants (PDA's), mainframes, telephones, televisions, watches, routers, switches or the like.

The computer 100 also comprises a printer 119 which connects to the I/O subsystem 116. The printer 119 provides a printing means and is arranged to print documents 180 therefrom.

FIG. 1 shows a scanner 122, which may be referred to as a scanning means, which is well known in the art, and which, in this embodiment, has been daisy chained through the printer to connect to the I/O subsystem 116. In the Figure, the scanner 122 is shown as being a flat bed scanner in which a physical document placed on the glass 124 is illuminated and the reflected light measured such that an electronic image representing the physical document is generated. Although the scanner is shown as a flat bed scanner it is likely that, as the volumes of physical document increase, a scanner having bulk medium handling facilities will be used. Other type of scanners can also be used and it should be appreciated that embodiments of the invention will work from the image of a document no matter how the image has been created.

It will be appreciated that although reference is made to a memory 114 it is possible that the memory could be provided by a variety of devices. For example, the memory may be provided by a cache memory, a RAM memory, a local mass storage device such as the hard disk 112 (i.e. with the hard drive providing a virtual memory), any of these connected to the processing circuitry 108 over a network connection such as via the transmitting/receiving means 120. However, the processing means 110 can access the memory via the system bus 118, accessing program code to instruct it what steps to perform and also to access the data. The processing means 110 then processes the data as outlined by the program code.

The memory 114 is used to hold instructions that are being executed, such as program code, etc., and contains a program storage portion 150 allocated to program storage. The program storage portion 150 is used to hold program code that can be used to cause the processing means 110 to perform predetermined actions and in embodiments of the present invention in particular provides a means of detecting advertisements in machine-readable documents.

The memory 114 also comprises a data storage portion 152 allocated to holding data and in embodiments of the present invention in particular provides a document store 155 which is used to hold the electronic images and also the intelligible digital form of the portions of the document that have been converted to machine-readable form.

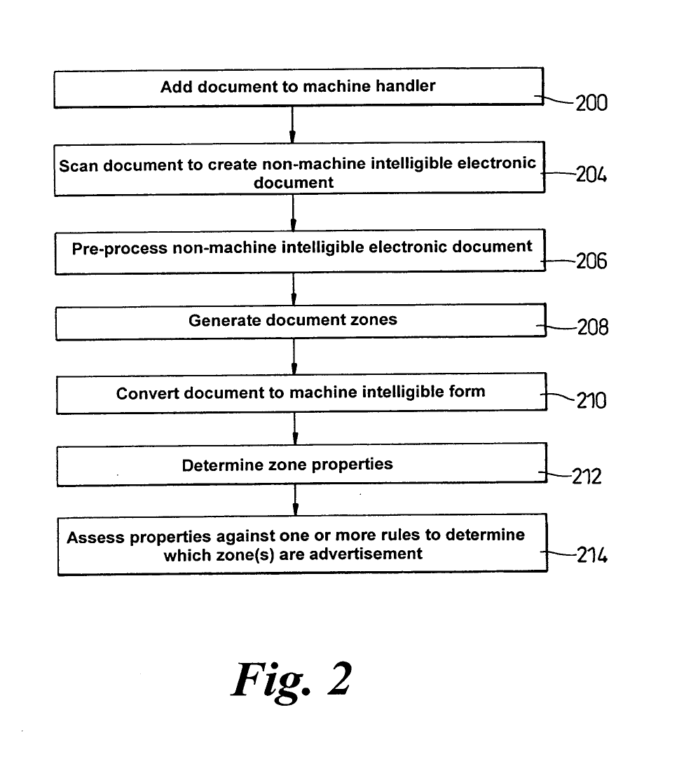

An embodiment of the present invention is described in relation to FIG. 2. Initially, in step 200, a physical document is added to a medium handler of a scanner and scanned 204 in order that a non-machine intelligible electronic version of the physical document may be created. Each physical document from which it is desired to convert to a machine intelligible form is scanned to generate a non-machine intelligible form of that document which is stored in the document store 155 of the data storage 152 portion of the memory 114. The non-machine intelligible form may be any suitable format such as any of the following non-exhaustive list: GIF (Graphics Interchange Format), a TIFF (Tagged Image File Format), JPEG (Joint Photographic Expert Group), PNG (Portable Network Graphics), or the like.

If the embodiment of the invention is being used to process electronic documents, rather than physical ones, then this first conversion process that generates a non-machine intelligible copy of the physical document may be omitted and the non-machine intelligible electronic document may be stored in the document store 155 of the data storage portion 152 of the memory 114.

In this embodiment the non-machine intelligible version of the document, held in the document store 155, is then processed with some pre-processing steps (step 206) to enhance its quality and remove defects such as scanning artefacts and the like. An advantage of such pre-processing steps is that it can enhance the robustness of the subsequent conversion from the non-machine intelligible form to the machine intelligible digital form.

A document analysis and understanding system operating on the processing means performs OCR (Optical Character Recognition) or ICR (Intelligent Character Recognition). The context in which letters and words are placed is used to help increase the accuracy of the conversion into the intelligible document form. For example, if initial analysis of a letter gave an equal probability of it being a ‘c’ or an ‘e’ but the word in which the letter occurred existed if it were an ‘e’ but not if it were a ‘c’ it would generally be determined that the letter were an ‘e’. Similar determinations can be used for words.

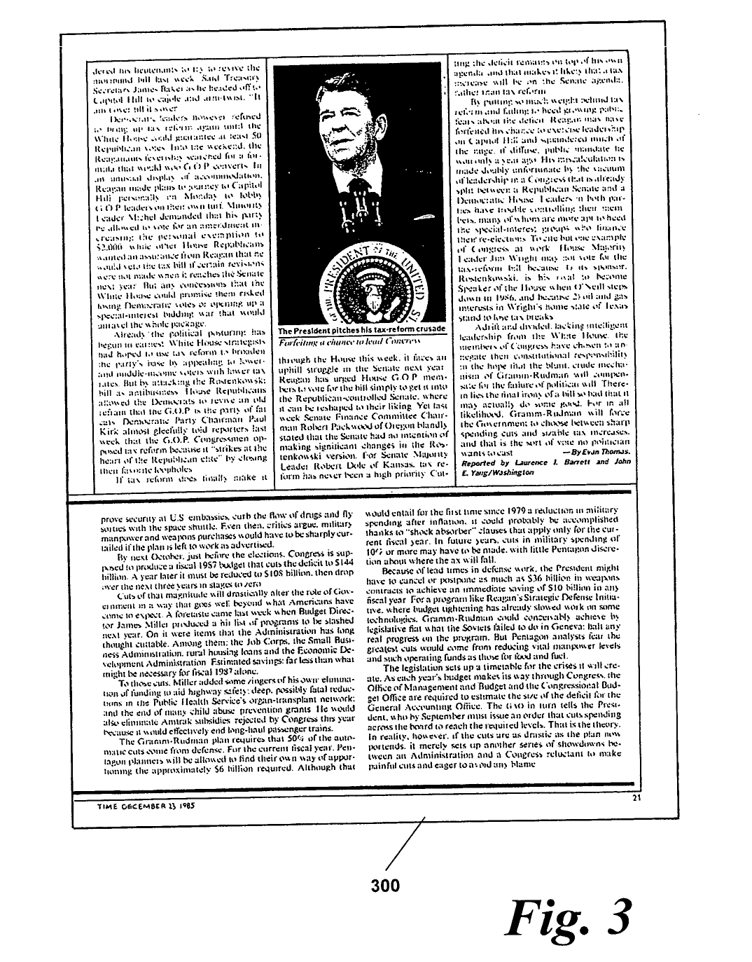

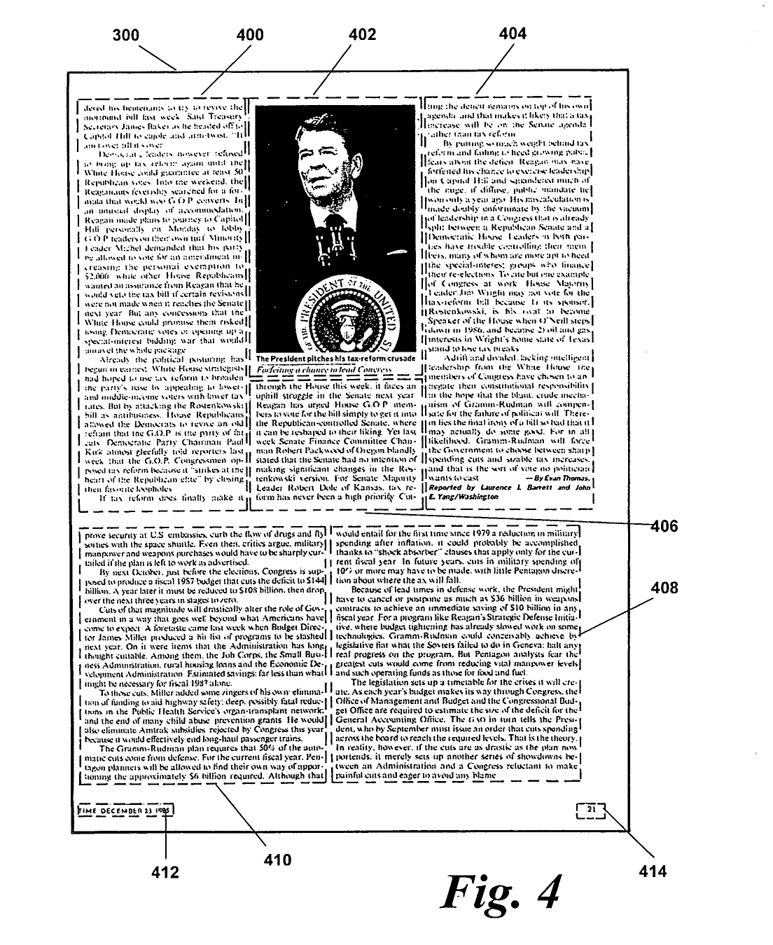

Once a non-machine intelligible version of the document has been stored in the document store 155, and pre-processing 206 is performed, further analysis occurs to generate zones within the document (step 208). Although such zones are well known in the art of document scanning, a short description follows with reference to FIGS. 3 and 4.

FIG. 3 shows a page 300 from a non-machine intelligible electronic document that has been generated by the scanner 122. FIG. 4 shows the same page on which, as determined by the zone processor 154, zones have been marked. A zone may be thought of as a portion of the document which is physically separable from other portions of the document by virtue of having a separator element existing around that portion, for example using blank spacing, lines; or having other properties such as background colour or typography that distinguish to the eye of the reader the zone as a self-contained physical element in a page (an example could be a caption close to a figure that is written in italic while it is not too far from other lines of article text, these written in regular font style). Referring to FIG. 4, it will be seen that the zone processor 154 has located eight zones 400 to 414 on the page 300.

Zone 400 is a typical example of a zone and comprises a column of text. The column of text providing zone 400 does not extend for the length of the page 300 since the column structure changes roughly two thirds of the way down the page 300, giving rise to a further zone 410.

In other embodiments, the zone processor may produce different zones from the page 300. For example, the page number (zone 414 in FIG. 4) may not be identified as a zone. As a further example, it will be seen that the zone 402 in FIG. 4 comprises an image together with a caption under the image. Other embodiments of the zone processor 154 may determine that the image and the caption provide two distinct zones. However, the result of the zone processor 154 acting upon the non-machine intelligible electronic document will generate at least one, and generally a plurality, of zones.

Looking at the zones on the page 300 as shown in FIG. 4 it will be seen that some of the zones may be connected to one another in some way; i.e. the content of a zone is connected to the content of another zone. For example, the zones 408 and 410 are likely to contain a portion of the same article. It is also likely that zones 400, 406 and 404 also each contain a portion of an article. This is readily apparent to a human observer but is not apparent simply due to the existence of the zones.

Generally, documents, both physical and electronic follow a series of layout rules. These rules can be used to interpret the zones generated by the zone processor 154 in order to determine which zones should be connected to one another (i.e. those which contain content which should be used considered as a whole).

Although the content of a zone 400 to 414 may be used to determine whether it should be connected to another zone this is not readily apparent at this stage in the process since a machine intelligible document has not yet been created. Therefore, the semantics of a zone may be used to help determine which zones should be connected. In other embodiments, the content of a zone may be used to help connect zones instead of or as well as the semantics of a zone.

Referring to FIG. 2, at step 212 the properties of a zone are determined. Examples of the properties that maybe determined include, amongst others, the position of the zone on the document page, the zone size and the content of the zone. Example properties are explained more detail later in this specification.

At step 214 the properties that have been determined for a zone or group of zones are assessed against one or rules to determine whether the zones should be classed as advertisements.

Various types of advertisement regions can be found, and the processing that can be used to detect each of these types of advertisement zones will now be described.

Classification of Advertisement Regions

Existing published material can be wrongly thought as a rule-free, chaotic type of drawing landscape, where designers have free reign to use their imagination to put their ideas on to paper. Such a view is partially wrong and, in fact, there are a number of rules of design that should not be broken, e.g., it is not recommended mixing two typefaces on one page unless some very careful typographic conditions are met.

Some of the processing described herein assumes documents to have been produced under the knowledge of some of these design rules. The strength of this assumption generally increases as the complexity of the document increases. For example, in the case of magazines, which are generally the most complex printed documents, the need to follow these rules is high if the document is to “look right”. Therefore, in most cases, the assumption that documents follow a number of design rules is not a limitation of the processing employed by embodiments of the invention.

The zones of a page can each be determined as a set of images and text strings that are related amongst each other by a relationship of proximity, contextual semantic, alignment or repetition.

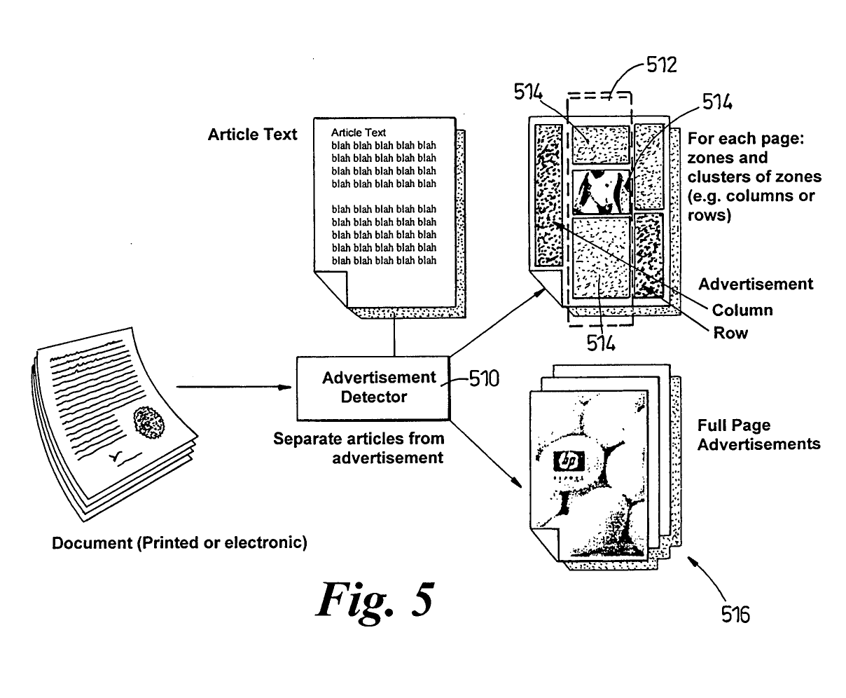

FIG. 5 displays an example of clusters 512, pages 516 and advertisement zones 514. For example a paragraph can contain a number of words that describe a common idea (contextual semantic), they are close to each other (inter-word distances), are aligned (baseline), and all words have the same typeface (repetition). A zone can be composed of several paragraphs if the page is divided into columns or rows that are close enough to each other. A set of images can also be related by semantics if they are composing a unique idea.

A whole page is considered an advertisement page when all zones in a page are advertisement zones.

The semantic of a zone is determined by the reason for which the zone has been included during the composition of the page. There can be different types of semantics, e.g., table of content zones, or page number zones. For the purposes of this specification the semantic of zones are described as advertisement or non-advertisement (article) zones. Advertisement and article semantics can be subdivided into finer grain categories, for example images can be further categorized as logos or full-page images. Similarly, text zones can be further categorized as titles, sections, footnotes, etc.

Clusters of zones are sets of zones that are grouped together by a common property which is referred to herein as a “criterion”. Examples of criteria can include, for example: “all zones in the cluster have the same font size,” or “all zones in cluster must have the same background color,” or “. . . are placed above a certain position,” or “. . . contain a certain keyword,” etc. A document is composed of pages, which are composed of clusters of zones and/or zones that are not to be grouped together. Each cluster contains one or more zones. Text zones can be subsequently divided into paragraphs, lines, words and characters.

Advertisement Detection

Various processes are used to detect whether the semantic nature of a zone belongs to an advertisement or an article category. They can be classified according to the scope of application in which they operate:

I Within Zones
This processing uses a single zone and is typically applied to all zones, unless some conditions occur, e.g., text zones not containing any words. Rules operating in a single zone use elements that are contained in that zone, for example in text zones such elements may be words, lines, characters and paragraphs.

II Within Clusters
This processing is applied to more than one zone and relate to the semantic, position, alignment, etc of the zones in the cluster.

III Within Pages
This processing considers the relationships among clusters in a page, the position of the cluster, semantic, etc. These algorithms define for example subdivisions of a page into columns or rows.

IV Whole Documents
This processing uses the information available across multiple pages, e.g., using the position of the page in a document, the semantic of a page (cover, back, table of contents, index, etc). Processing in this category may also validate decisions that zones are advertisements by determining the correspondences between left hand and right hand pages (which may be numbered as odd and even pages), e.g., if two pages are consecutive one odd and the other even, and there is a high degree of correlation on what they are describing (double pages), then they share a single semantic.

V Several or Many Documents
This processing captures statistical data on the findings for each document and reuses that knowledge in further classifications. For example, if it is known that all documents are magazines of the same type or published in the same historical period, then rules based on typography or layout can be applied with more certainty.

Processing Within Zones

This processing uses rules based on the following properties:

Position

Rules can be based on the position of the zone on a document page. These rules help to increase efficiency of further semantic-based processing, e.g., dates need to be in a given position. Such rules may be used, for example, to detect headers, footers, footnotes and margins.

Size

Rules based on the size of a zone can be used, for example, to help tag images as logos when they are below a certain size or advertisement pages when images are of the size of the page. Such rules can also help refine semantic-based algorithms, e.g., when the zone has the size of one line of text (1-liners), or for junk zone detection, etc.

Content

The semantics of the zone can be determined based on the content of the zone. This is particularly useful for text zones. For example, if a text zone contains the sentence: “get free subscription calling 1-800” then this can be determined to be an advertisement zone. For this type of rule there are different dictionaries/lexicons that can be used:
Advertisement markers: Markers are words or sentences that indicate a page or a zone is an advertisement. Examples may be words or phrases such as “subscription”, “buy one get one free”, “price”, “reduction”, “special offer”, “cheque”, “cash”, “credit card”, etc.
Trade names: Trade names such as product names, trade marks or company names appear regularly in advertisements. Rules associated with trade names need to distinguish from proper references to trade names within article zones. For example text zones in an advertisement page usually refer to the same product or company. Rules can be created to exploit these differences. When a trade name is found in a zone, the zone can be given a strong weighting that it is an advertisement rather than an article due to the presence of certain keywords such as “buy now and pay later . . . ,” or “get our free catalog . . . ”, etc.
Geopolitical: Names of countries or cities, presidents, mountains or other encyclopedic names can be chosen to represent a subtitle that reoccurs in pages and documents. Whether such words indicate that a zone is an advertisement depends on the context of the publication. For example in Time magazine the name of countries was used as subsection for articles, so in that case finding a subtitle text zone with the name of a country is a strong indicator that the following zones will be part of an article.
Reserved keywords: Reserved keywords are words or sentences that may appear often in the page as a reference of the context but not to the actual content of a zone. For example the text zone containing the words “Time, your weekly-news magazine” would repeat in Time magazine as a page header. Finding such text zones above a certain high in the page would confirm the rules of the zone being flagged as header. The same wording was also found in advertisements from the magazine itself (i.e. advertising Time magazine), and in these cases the position of the text zone was necessary to determine the semantics of the zone.
Section keywords: Section keywords are words and sentences that are used in titles to indicate a section. Such keywords often repeat in other pages of the document, and generally repeat from document to document. Such section keywords can be used to help identify both articles and advertisement. Algorithms working at the multi-document level can help building these dictionaries to achieve higher accuracy over time (learning period).

A library of “trigger” words, or numbers (such as 1800) can be created and when a match for one of the key words is made the application of a rule can be triggered. Content-based rules can determine that a zone is an advertisement or an article or other non-advertisement zone and also provide a weighting to the semantic determination. The weighting can be thought of as an accuracy or confidence level that may be determined statistically from the analysis of a body of documents. Rules using nearby text zones that have certain keywords, can be used to analyze the meaning of the zone in question. Such rules can be used to determine whether the number “1800” is a year or part of a free customer-service telephone number in advertisement.

Type

Rules can be formulated to use properties such as typeface and type properties to classify zones, e.g., zones with font size smaller than 7 pt are generally not regular article text.

Semantic Finders

Semantic finders are designed to detect certain kinds of zones and assigning them to a given semantic class. Semantic finders can be algorithms that exclude advertisement by finding other types of semantics. Alternatively, some of these algorithms will be targeted to directly find advertisement zones, for example, some pages look like articles but they contain the headers such as “this page is an advertisement” as a pointer to help the reader appreciate the difference. Embodiments of the invention can also benefit from such pointers. Very often this happens on advertisement for medicaments or health-care services. This processing relies on previous rules/processing (type, size, etc.) to achieve a higher level of accuracy. The processing detects, for example, dates, volume numbers, authors, issue numbers, page numbers, titles, captions, manifests, footnotes, letters to the editor zones, etc. For example, dates can be found in a page by detecting a 1-line zone containing a month or year (or a portion of them), detecting a zone having few words not larger than a given size, detecting a zone in a given position of the page and/or detecting a zone having typographic characteristics that are different from the ones used in the main body. Another example of this type of rule can be used to find junk zones. Junk zones are zones with no meaning that may be present as artifacts resulting from OCR processing.

Processing Within Clusters

Zones are determined to be part of a cluster of zones using the following properties and rules.

Alignment

Rules may be used to detect whether zones are aligned in a particular manner, e.g., in multi-column documents the first body zones of the columns are aligned so that their top most part matches. Alignment is one of the main properties of a well-designed document.

Type

Whereas the typeface is considered as the type of font used, for example defining that characters are in the Arial font, the type of the text includes properties on how these characters are laid on the page, for example the type may define kerning, inter-word spacing, etc. Some rules may consider the typeface of text zones, but some others may look at spacing or whether characters are bold, italic, etc. Assuming a well-designed page all zones of the same category will have similar properties in their type. For example, all subtitles in a page must provide a homogeneous “look and feel”.

Color

Color related properties of zones such as contrast, saturation and brightness can be used to identify zones as belonging to the same cluster. Such properties can be assessed for the foreground and/or background of a zone. Generally, zones in the same cluster have the same or similar color related properties. Color related properties are useful, for example, to detect insets since in some publications an inset is a portion of a page that has different color, for example yellow or reddish. Another way to delimitate areas in a page is by the use of lines or rectangles around a group of zones. If a cluster of zones are placed together (e.g., in the same vicinity to each other or neighbouring each other), aligned and all having the same background color, it is a clear indication that the zones belonging to the same semantic unit. Contrast is also one of the main properties of well-designed documents.

Position

Clusters may be detected based on the proximity of zones or the grouping of zones in columns and/or rows.

Size

Zones of the same width can be determined to be part of the same column and this information can be used to decide if the zones form a cluster.

Content

The semantics of a cluster can be determined based on the content of the cluster. For example, if most of the zones in a column are advertisements it is very likely that all of them are.

Property

Other properties of a cluster such as text density, number of fonts used or rate of covered area on the cluster can be used to determine the semantics of the cluster. This is a very powerful set of algorithms, e.g., if the area covered by zones in the column is less than, say, 30% of it, then the column is most probably an advertisement column. There is generally a strong correlation between empty space in page and the page being an advertisement page. The rate of coverage indicates, as a percentage, how much surface on the page is left blank.

Processing Within Pages

Processing within pages uses rules based on the following cluster and zone properties:

Special Keywords

If some special keywords, e.g., advertisement markers, are detected in page, then all zones and clusters in the page are to be marked as advertisement. Examples of such special keywords may include “advertisement”, “classified”, “ads”, “To let”, “Cars”, “Services” etc. It will be appreciated that a particular set of keywords can be used for a particular publication, for example a particular magazine title, and possibly there is a different set of keywords for respective different magazine titles. For example, in time magazine there is a repetitive header that appears often with the message “Time Magazine—the weekly news-magazine”.

Number of Zones with Common Semantics Per Page

For example if all but one zone in a page are detected as advertisement, that zone left will also be marked as such. Thresholds can be set, discovered and statistically validated, for when a page should be marked as an advertisement or an article. For example, it may be determined that if a page contains seven zones of which five are detected as advertisements then there is a high statistical probability that the remaining two zones on the page are also advertisements. Five out of seven corresponds to a threshold level of 71%, the system can change this threshold so that, for example for older issues of a publication, in which variability on the pages is lower, the threshold may be set to, say, 90%. It was noted that for newer issues Time magazine (after the 1980's for example) the variability on page layout dramatically increased, e.g., alignments can also be in diagonal rather than just horizontal or vertical.

Area Rate Covered Per Page

Area rate covered per page is the surface area of the page that is “occupied” by a valid zone (non junk zone). Additional measurements are taken to indicate the amount of coverage for each of the zone semantics e.g., with advertisement, article, and layout-support zones such as footnotes, dates, page numbers, etc. There is a strong correlation between “page emptiness” and the page being an advertisement. That correlation is also measured, and the threshold tuned over the years of publication.

Text Density

The text density of a page can be measured in a number of different ways, e.g., number of words, characters, and text zones. There can be problems with text zone rates that cover a large surface of the page but are of very low density. For example components of OCR processing may report a large text zone covering an important section of the page, but actually containing very little text. That may cause problem because in fact the “page emptiness” is an indicator of an advertisement. In some cases the large text zone may only contain a few characters but the whole of the text zone can be covered, e.g., if the characters are of large font size. That is also an indication of the zone being an advertisement—although later in the analysis of the document it can be that this zone is actually part of an article first page, where usually there is little more than a picture and a large title. These cases can be detected and are usually result of a bad zone detection process. To eliminate errors the rules may be simplified so that they only consider the density in valid text and cluster zones.

Type and Font Variability

Type and font variability can also be measured in different ways depending on the accuracy required, e.g., counting the number of different font families, typefaces and even considering variations within each of these such as changes from roman to italic and bold. Usually there is not a large difference in the font variability of advertisement when compared to article zones. However, since there is usually more text in articles than advertisement, the ratio of font variability to text density is higher in advertisement than in articles.

Interline Space Variability

Interline space variability is an additional measure related to type, helps increasing the accuracy on the selection of type that has been decided by the OCR. For well-designed documents all lines within a single paragraph will have the same interline space. In addition, all paragraphs that correspond to a common contextual unit, e.g., within a column cluster of article text, will generally have the same interline space between their lines.

Font Size Variability

Font size should remain constant within a paragraph, and among article text paragraphs. Exceptions appear when some typographic contrast has been used purposively. These cases can be detected as such and often appear in some new magazine media, for example some magazines do not follow traditional patterns and may use bold designs. Although it may be thought that advertisement pages tend to make use of these features more than regular text article pages, this measurement turns out to be not very significant for advertisements. More relevant results appear when applying the processing to clusters and zones of specific semantics, e.g., article body text ones, and maybe referred to as filtered font size variability measurements. Such measurements distinguish between, for example, titles and article body text zones. In advertisement clusters the embodiment will have larger filtered font size variability than article embodiments.

Number of Lines Per Zone

The number of lines per zone is a measurement that is used in rules deciding for the semantic of a page, e.g., if all the zones in a page are 1-liner zones, it is probably not a regular article page, unless some other conditions appear.

Number and Shape of Columns and Rows

The number and shape of columns and rows is a property that can be used to decide whether a page is article or advertisement. For example, a 3-column page is more likely an article than an advertisement page unless some other conditions are met.

Processing Within Documents

Processing with documents use rules based on the following properties:

Indexes.

Tables of content or index pages can be analyzed to find out which pages on the document contain articles and sections, e.g., letters to the editors. The semantics of pages and zones in pages will be validated when they are found in indexing regions.

Double Pages:

Double pages are two consecutive pages, i.e., a left hand page and a right hand page (which may be numbered as odd and even pages respectively, or conversely as even and odd pages), with images or text zones that are spread across both pages, for example with a title center in the union of both pages. In this case if the semantic meaning of one of the pages is known with a high degree of certainty, then this semantic propagates to the other page. Another example is when the left hand page of a double page pair is found in a table of contents as an article, then the right hand page is also determined to be an article page.

Redundancies:

Redundancies can often be found in some of the properties of a page. For example the type-based clustering analysis on each page should provide well-known information about the article-body text across a magazine. One of the main graphic design principles is repetition. There are a number of rules exploiting this design requirement. One principle of graphic design is the use repetition. This is because people find it easier to read information that follows a repetitive structure. For example if page numbers were randomly placed in each page of a document, a user would find it difficult to use the page numbers, the page numbers may distract the reader from the other content on the page and generally the quality of the reading experience would be lessened. Once the page numbers appear in a predictable place the reader's eye stops noticing them and focuses on what is relevant in a page. This repetition principle also guides that all text zones on the same article should share common font size and typography. All titles across a magazine should usually by of the same size and typeface to help readers recognize them as titles. Repetition is a principle guiding most designers to compose their layouts and can be exploited when determining the semantics of zones.

History.

The history of publication is important when analyzing documents over a long period of time, e.g., several decades. Typography and graphic design principles, as well as some of the printing technology available at that time, have evolved through the history. The processing can exploit these rules based on the publication date on which an article or magazine has taken place. For example, page variability is generally low in old issues of a magazine, that is, the properties of the page are more consistent from page to page. Also the number of advertisements is also generally lower in old issues of a magazine.

Processing Applied to Many Documents

Processing can be applied to a body of documents using rules based on the document, page, cluster, and zone properties.

Dictionary Management

Dictionary management processing extracts and maintains keywords on the different dictionaries/lexicons previously described in relation to processing within zones. Dictionaries will evolve with time, so the view on the keywords contained may be different depending on the point in time that the document was published.

Layout Management

Each page of a document can be defined as following a layout template. A template comprises information on the positions of zones on the page—i.e. the page layout. Some layout templates correspond to article pages and some layout templates correspond to advertisement pages. A template analysis over a set of documents (of the same kind) allows refinement of the decisions on the semantics of each page. For example the thresholds for page emptiness used to indicate an advertisement can be refined as more documents in the set of documents are analysed. Templates can be used when repetition features are detected across pages and issues. If some pages have a high confidence level assigned to their semantic, the fact that other pages follow exactly the same layout is a good indicator that these other pages have the same semantics. It is often the case that the same advertisement—a picture or a message—repeats exactly in different magazines or different issues of the same magazine. This determination can be used to either corroborate or modify the punctual analysis for that page. According to another example, an analysis may initially report a page being the first page of an article because that page appears in the table of contents, but subsequently it is determined that the same page occurs everywhere in the document and is determined, with high confidence to be advertisement. In this case a decision can be made that the detection based on the table of contents did not produce a good result and the detection result can be modified.

Repetition

A set of algorithms can be used to look for repeating elements. For example the position of some of the pages, such as the table of contents page, remains almost constant from document to document in a particular publication over a period of time. Repetition processing can be used to find advertisements that repeat from issue to issue, e.g., using a trade name dictionary and linking layout information to trade names. Layouts that have been identified as advertisements with a high confidence level can be “tagged” with the product or company that they represent, e.g., using text zones contained in the advertisement. If that tag is found in other pages an analysis comparing the two layouts can be triggered. If the layouts compare well then the other pages can also be determined to be advertisements.

Architecture

This section describes an implementation that supports the processing described above. It is not the only suitable implementation and some other rule-based systems could be used to implement the processing.

The architecture here described has a self-adjusting capacity to verify decisions that are taken all through each step of the process. We call these capabilities the finder-filter principle and it will be described in this section.

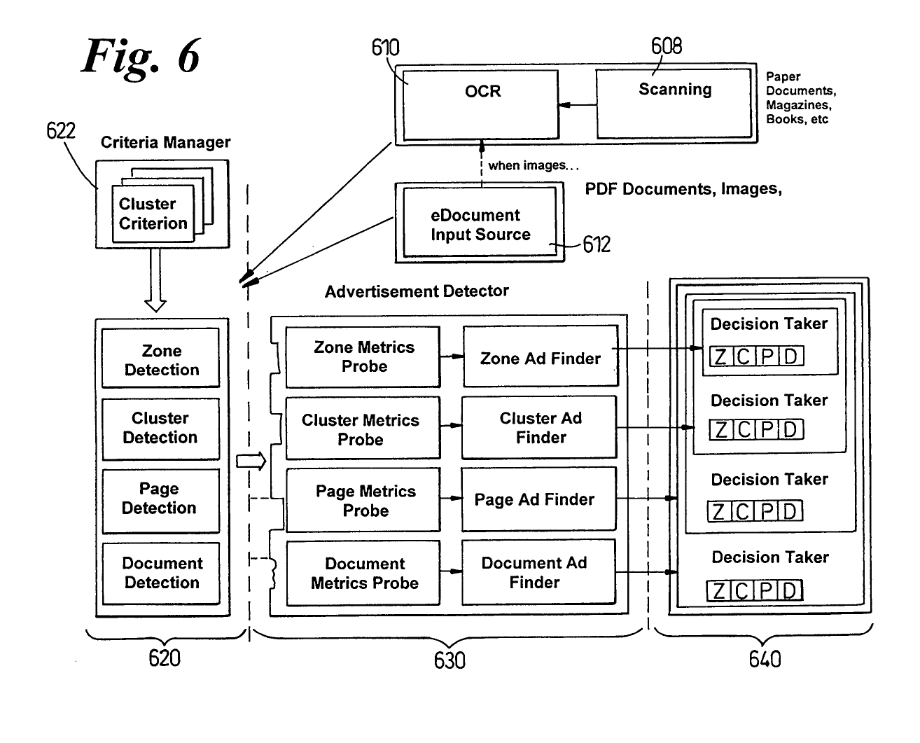

Referring to FIGS. 5 and 6, an advertisement detector 510 is a component that marks documents, pages, clusters and zones within a page as advertisements. Usually the advertisement detector 510 is a critical part in a semantically based document analysis solution. FIG. 5 displays the functioning of the advertisement detection in the context of a broader-scoped analysis in which advertisements and/or articles are extracted from a document.

Referring to FIG. 6, documents can be processed from paper or electronic sources. A document scanning phase 608 and an OCR phase 610 are required when paper, or some other non-electronic media, supports the document. The OCR processing allows for the system to pass from paper, or other physical medium, to a computer-suitable representation. The computer-suitable representation is usually in XML format although other representations could be valid. Electronic documents 612 in vector based formats, such as PDF format, would generally not need to go through the OCR phase 61 although PDF formats containing binary images may need to go through OCR to obtain text form these images. Electronic documents 612 in image formats such as TIFF, JPEG, etc., would need to undergo OCR.

A document preparation component 620 prepares the document so that the document is suitable for further processing. This consists of detecting all the composition elements (regions) in a document, including: zones, clusters of zones, pages and documents. A zone can be a text zone, a graphic (image) zone, or extensions of these, e.g., a table zones as an extension of a text zone, or drawing zone as extension of a graphic zone. Other zone types are allowed and are useful for refining the semantics on the page.

A special zone type is ‘junk” that can be used for marking elements on the page that will avoid processing and are to be removed from the processed document.

In a rectangular text zone filled with words there will be a number of lines that will contain words, once these words are joined, and punctuation symbols, found the analysis can consider sentences. Words can be created from joining the characters and there are special cases where hyphenation rules can be applied. A Criteria Manager component 622 assists the document preparation component 620 by providing a set of grouping functions or criteria. Each of the grouping functions or criteria helps, for example, to group words in a line, to group lines in zones, zones in columns and pages in sections

When creating zones from an original image/page the criteria manger identifies whether clusters of zones are pictures or text zones. When necessary OCR algorithms are applied to these zones to recognize characters and constructing words. Words can be determined based on the average inter-character space found in the text, and then lines of text can be identified according to baselines that are determined from the text. A baseline can be thought of as an imaginary line that shows the horizontal alignment of an occidental set of characters, for example the baseline may run through, or immediately beneath the lowermost portion of the characters. After this stage the document still has not been assigned any semantics, that is whether the regions are advertisements or not. Rather the individual physical elements in the page have been identified. The document preparation component 620 uses the criteria with the goal of producing a representation of the document as a set of grouped elements. In this way, the document becomes ready for further analysis.

After the document preparation, advertisement detection is achieved using a set of finder-filter pairs. A finder subcomponent 630 part of the processing comprises measuring a number of properties on document elements, and then assigning a semantic value to some of these elements based to the rules described in the previous section.

The metrics/properties that are used, as well as the rules that are applied, will depend on what elements from a Set of Semantic Elements (SSE) are being analyzed, e.g., it can be number of words in a zone, average font sizes, etc. The finding rules will be based on the metrics given by the probes (probes are elements that measure certain properties of the documents) and compare the metrics against a set of rules and thresholds to provide all the information possible to a filter component 640.

The filter 640 component is used to make decisions on the assignments to the zones or other structures of the document. The filter components will use the information provided by the finder to make the decisions. The filter components can also use additional information that can arrive to the system through alternative channels. For example, humans that review the material may update the dictionaries, or the thresholds that are automatically tuned come to the system as an external feedback. The filter component 640 can then implement rules and thresholds to make a decision about the semantic of zones, clusters, pages and documents. All through the processing of a document, these decisions may change, based on the fact that more information is available as the processing evolves.

The filter components are represented in FIG. 6 as a set of decision-taking boxes. The decision-taking boxes contain elements that operate following the same principles of decision-taking, but at different levels, e.g., some rules may be applied the same way within clusters as they are within zones. The rules change and the elements are different, but the mechanism to take decisions is the same.

In principle, the more information that is available the more accurate the decisions when assigning a zone or other document region a particular semantic. Decisions can be taken on all elements of the SSE as soon as there is a new piece of information that can help the decision making process. For example, a zone-based decision can result in marking a text zone as advertisement based on its content (finding), and later on changing it back to article if that zone belongs to a cluster of article zones (filtering).

An amplification factor can sometimes appear on errors, i.e., if an error is made it could propagate all through the system affecting other decisions. For example, an error in the table of content detection is significant because it may determine that an advertisement page is an article (because sometimes the first page of an article looks like an advertisement, mainly because there is little on it other than an image and a small amount of text). The cascading problem can be caused if the wrong determination is followed and then layout matching that uses this determination can therefore also be wrong, and many other decisions will also be wrong as the error amplifies. However, contradictions can appear in these cases and such contradictions can be detected. Newly available information is weighted in the system to help minimize the amplification factors.

Decisions taken by the system can each be given a confidence level. The inverse of that confidence level is correlated with the risk involved in taking such decision. The overall decision process becomes more acute on the answer, i.e. decisions acquire a greater confidence level, as more information is processed.

Another example of finding-filtering is when all of the zones in a column are provisionally or initially identified as advertisement (finding) as result of most of them having been marked as so. If later it is determined (filtering) that a section keyword is heading that column, the provisional decision may be revoked and new decision may be made to mark the whole of the column as valid article text.

Once an advertisement region has been detected there is the option to remove the advertisement region from the electronic version of the document or to keep the advertisement in the document. If the advertisement region is removed then the removed region may be stored, for example in computer memory. Similarly, if the advertisement region is kept in the electronic version of the document then a copy of the advertisement region can be made and this copy stored.

If the advertisement region is kept in the document then once an advertisement region is detected the degree of readability of an article in a page on which the advertisement region has been inserted can be considered. In this way the effect of the insertion of the advert on the readability of a document can be assessed. In a similar fashion the level of quality of the designed page that includes the advertisement can be measured. This may be of interest to publisher, the company who placed the advert, and/or the author of any article that accompanies the advertisement on the page. The level of quality can be measured using new software tools, for example, integrated as plug-ins for Quark or Illustrator. Quality parameters that can be measured and on which rules can be constructed include the alignment of text within a text block, the alignment of text and image blocks with each other and consistency of font properties across different zones, and in different pages.

1. A computer-implemented method of detecting advertisements within a document comprising using a computer to:
identify at least one region within an electronic version of the document;
determine at least one property of the at least one region; and
determine whether a region is an advertisement according to rules applied to the properties of the at least one region.

2. The method of claim 1 wherein the at least one region comprises at least one region chosen from the following region types: (i) zones; (ii) clusters of zones; (iii) single document pages; (iv) multiple document pages; and (v) and any combination of (i) to (iv).

3. The method of claim 1 wherein the determination that a region is an advertisement is made according to rules applied to properties determined from a plurality of documents.

4. The method of claim 1, comprising removing at least one region determined to be an advertisement from the electronic version of the document to produce a document that does not contain the at least one region determined to be an advertisement.

5. The method of claim 4, comprising storing in a computer memory the at least one advertisement region removed from the electronic version of the document.

6. The method of claim 1, comprising storing in a computer memory a copy of at least one region which is determined to be an advertisement.

7. The method of claim 1, wherein the determination that a region is an advertisement comprises:
making a provisional determination that a region is an advertisement;
making a decision as to the correctness of the provisional determination based on the subsequent determination of the properties of other document regions; and
changing the provisional determination if it is decided that the provisional determination is incorrect.

8. The method of claim 2, wherein the at least one property determined comprises at least one property of a document zone chosen from:
(i) the position of the zone on a document page;
(ii) the size of the zone;
(iii) the amount of text in the zone;
(iv) the typeface of the zone;
(v) the type of the zone;
(vi) the content of the zone; and
(vii) any combination of (i) to (vi).

9. The method of claim 2, wherein a plurality are zones are determined to belong to a cluster of zones if the zones satisfy rules chosen from:
(i) the zones are geometrically aligned in a specified manner;
(ii) the zones have the same or similar typography;
(iii) the zones have the same or similar formatting;
(iv) at least one of the color, contrast, saturation and brightness of the zones are the same or similar; and
(v) any combination of (i) to (iv);
and wherein, when a plurality of zones is determined to be a cluster, a region is determined to be an advertisement in accordance with rules which apply when a plurality of zones are determined to be a cluster.

10. The method of claim 2, wherein a plurality are zones are determined to belong to a cluster of zones if the zones satisfy rules based on properties chosen from:
(i) the proximity of the zones to each other;
(ii) the position of the zones relative to each other;
(iii) the content of the zones;
(iv) the text density in the zones; and
(v) any combination of (i) to (iv);
and wherein, when a plurality of zones is determined to be a cluster, a region is determined to be an advertisement in accordance with rules which apply when a plurality of zones are determined to be a cluster.

11. The method of claim 1, wherein the at least one property determined comprises at least one property of a document page chosen from:
(i) the number of zones on the page having a common semantic;
(ii) the coverage of the page by the zones having a particular semantic;
(iii) the text density on the page;
(iv) font variability;
(v) font size variability;
(vi) interline space variability;
(vii) the number of lines of text per zone for the zones on the page;
(viii) the number of columns;
(ix) the number of rows;
(x) the shape of columns;
(xi) the shape of rows; and
(xii) any combination of (i) to (xi).

12. The method of claim 1, wherein for a multi-page document the method comprises:
determining a page or pages contain a table of contents;
analysing the table of contents to determine which pages of the document contain articles; and
determining the zones in those pages to be article zones.

13. The method of claim 2, wherein if a zone spreads across a first page and a consecutive adjacent page and the first page is determined to be an article page then the consecutive adjacent page is also determined to be an article page.

14. The method of claim 2, wherein for a multi-page documents the method comprises:
determining a zone spreads across a first page and a consecutive adjacent page; and
determining the semantic of the consecutive adjacent page to be the same semantic as the first page.

15. The method of claim 1, wherein the rules are generated from information gathered from a plurality of documents, the method comprising formulating a lexicon of terms by extracting and maintaining terms held in lexicons associated with individual documents.

16. The method of claim 1, wherein the rules are generated from information gathered from a plurality of document issues, the method comprising identifying elements that repeat from document issue to document issue.

17. The method of claim 16, wherein the repeating element is a trade name.

18. A method of detecting advertisements within a document comprising:
using a computer processor to process an electronic version of the document to identify at least one region within the document, the at least one region being chosen from the following region types: (i) zones; (ii) clusters of zones; (iii) document pages; (iv) multi-page documents; (v) any combination of (i) to (iv);
using a computer processor to determine at least one property of the at least one region; and
determine whether a zone is an advertisement according to rules applied to the properties of the at least one region;
and to extract the determined advertisement zones from the electronic version of the document.

19. A system for detecting advertisements within a document comprising a processor adapted to:
identify at least one region within an electronic version of the document;
determine at least one property of the at least one region; and
determine whether a region is an advertisement according to rules applied to the properties of the at least one region.

20. The system of claim 19, wherein the processor is adapted to remove at least one region which has been determined to be an advertisement from the electronic version of the document to produce a document that does not contain the at least one region determined to be an advertisement.

21. The system of claim 20, comprising a computer memory for storing the at least one advertisement region removed from the electronic version of the document.

22. The system of claim 19, comprising a memory for storing a copy of at least one region which is determined to be an advertisement.

23. The system of claim 19, wherein the determination that a region is an advertisement comprises:
making a provisional determination that a region is an advertisement;
making a decision as to the correctness of the provisional determination based on the subsequent determination of the semantics of other document regions; and
changing the provisional determination if it is decided that the provisional determination is incorrect.

24. A computer program product encoded with software which run on a processor, is adapted to:
identify at least one region within an electronic version of the document;
determine at least one property of the at least one region; and
determine whether a region is an advertisement according to rules applied to the properties of the at least one region.
